(19) United States
(12) Patent Application Publication
(10) Pub. No.: US 2019/0038056 A1
(43) Pub. Date: Feb. 7, 2019

(54) PASTRY COVER AND METHOD OF MAKING THE SAME

(71) Applicant: Fred Pye, Albuquerque, NM (US)

(72) Inventor: Fred Pye, Albuquerque, NM (US)

(21) Appl. No.: 15/669,855

(22) Filed: Aug. 4, 2017

(51) Int. Cl. A47G 19/26; F21V 35/00

(52) U.S. Cl. CPC A47G 19/26; F21W 2121/002; A47G 2400/061; F21V 35/003

(57) ABSTRACT

A pastry cover for holding one or more candles. The pastry cover defining one or more candle holding divets. The candle holding divets may vary in shape, size, and depth to accommodate a variety of types and shapes of candles and occasions.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

Often, when a person is celebrating an occasion a pastry is involved. Many times to further commemorate the occasion, candles may be placed onto and into the pastry. The person may be asked to blow out the candles as a final mark of the occasion. When the person goes to blow out the candles debris, such as saliva and germs, may make their way onto the pastry. Even without the person blowing out the candles, an uncovered pastry surrounded by the person and multiple other participants may lead to saliva and germs making their way onto and into the pastry. There exist a need to protect the pastry from debris while also allowing the person to blow out their candle and people in general to celebrate any occasion.

### BRIEF SUMMARY OF THE INVENTION

This Summary is provided to introduce some general concepts relating to this invention in a simplified form that are further described below in the Detailed Description. This Summary is not intended to identify key features or essential features of the invention.

In one embodiment, a pastry cover for holding candles is provided. The pastry cover includes a main body. The main body includes at least one pastry vertical wall and an attached pastry top horizontal portion. The pastry top horizontal portion defines at least one candle holding divet. The candle holding divet is further defined by at least one divet vertical wall and an attached divet bottom horizontal base. The divet horizontal base is parallel to the pastry top horizontal portion.

In another embodiment, a method of making a pastry cover for holding candles is provided. The method includes providing a main body. The main body includes at least one pastry vertical wall and an attached pastry top horizontal portion. The pastry top horizontal portion defines at least one candle holding divet. The candle holding divet is further defined by at least one divet vertical wall and an attached divet bottom horizontal base. The divet horizontal base is parallel to the pastry top horizontal portion.

Other aspects, systems, methods, features, and advantages of embodiments will be, or will become, apparent to one of ordinary skill in the art upon examination of the following figures and detailed description. It is intended that all such additional aspects, systems, methods, features, and advantages be included within this description and this summary, be within the scope of the invention, and be protected by the following claims.

### BRIEF DESCRIPTION OF THE DRAWINGS

The embodiments can be better understood with reference to the following drawings and description. Components in the figures are not necessarily drawn to scale, emphasis instead being placed upon illustrating structural and functional principles of the embodiments. Like reference numbers in the figures designate corresponding parts throughout the different views, and the initial digit or digits of each reference numeral may indicate the figure number of the first figure in which the part is identified in the figures.

FIG. 1 is a schematic view of a pastry cover defining at least one candle holding divet, in accordance with aspects of the present invention;

FIGS. 2A-2B are cross-sectional views of the at least one candle holding divet of FIG. 1, in accordance with aspects of the present invention;

FIG. 3 is a perspective view of the pastry cover of FIG. 1, in accordance with aspects of the present invention;

FIGS. 4A-4C are perspective views of pastry cover of FIG. 1, in accordance with aspects of the present invention;

FIGS. 5A-5B are perspective views of the pastry cover of FIG. 1, in accordance with aspects of the present invention;

FIG. 6 is a perspective view of the pastry cover of FIG. 1, in accordance with aspects of the present invention; and

FIG. 7 is a view of a method of making aspects of the pastry cover of FIG. 1, in accordance with aspects of the present invention.

### DETAILED DESCRIPTION

The present detailed description generally describes embodiments of methods of making a pastry cover and embodiments of a pastry cover made by such methods. Additionally, references to a singular item or characteristic is not limited to a singular term. Singular references to an item or characteristic may include the plurality of such item or characteristic. Similarly, plural references to items or characteristics may include the singular of such items or characteristics. Singular and plural forms may be used interchangeably without changing the meaning or scope of the invention.

The present invention relates to a pastry cover that is configured to cover a pastry and hold candles. A pastry may include any type of baked good such as, but not limited to, a cake, pie, brownie, or cookie. The pastry cover may be configured in size and shape to best fit each type of pastry.

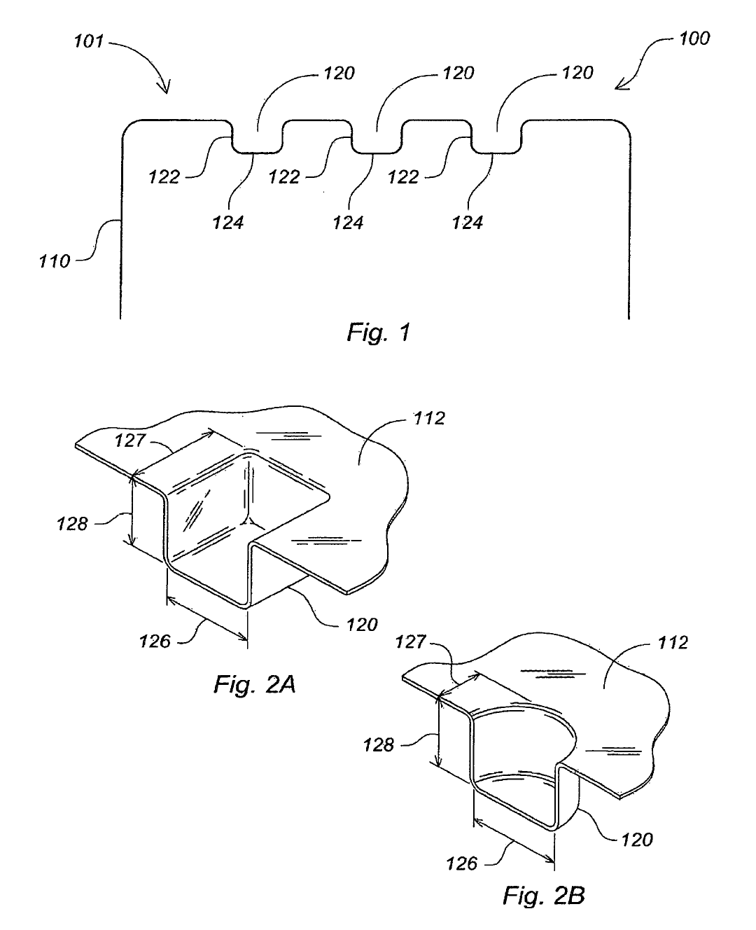

Turning to FIG. 1, a schematic view of a pastry cover 100 is provided. Pastry cover 100 includes a main body 101. Main body 101 has at least one pastry vertical wall 110 attached to a pastry top horizontal portion 112. Pastry top horizontal portion 112 defines at least one candle holding divet 120. Candle holding divet 120 is further defined by at least one divet vertical wall 122 and an attached divet bottom horizontal base 124. In some embodiments, divet bottom horizontal base 124 is parallel to pastry top horizontal portion 112.

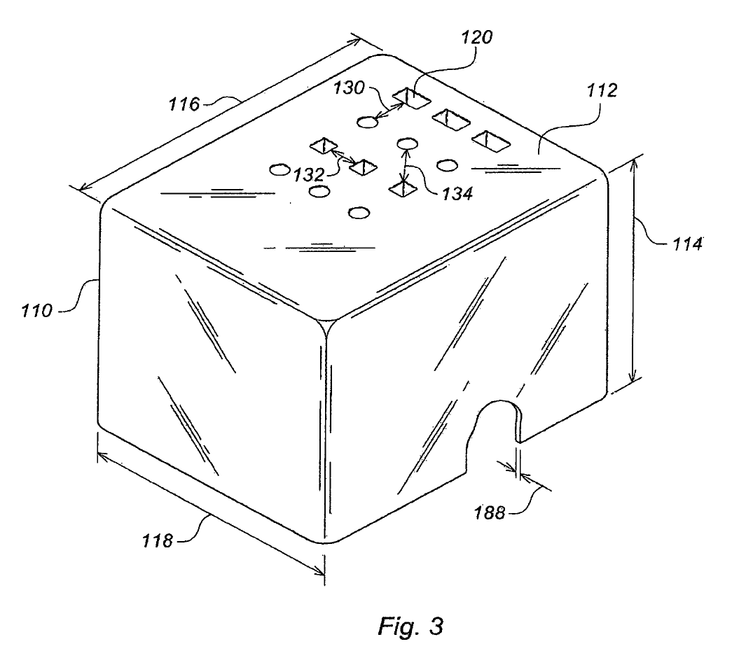

FIGS. 2A-2B illustrate cross-sectional views of a candle holding divet 120 of main body 101 of pastry cover 100. Candle holding divet 120 has a divet width 126, divet depth 127, and divet height 128. In some aspects, divet width 126 is equal to divet depth 127. In other aspects, divet width 126 is greater than divet depth 127. In further aspects, divet width 126 is lesser than divet depth 127. Additionally, divet height 128 may be equal to, greater than, or less than divet width 126 and or divet depth 127. Divet width 126, divet depth 127, and divet height 128 may each vary between 0.635 centimeters (approximately 0.25 inches) and 13 centimeters (approximately 5.11811 inches). In other aspects, divet width 126 may be 1.27 centimeters (0.5 inches) or 0.9525 centimeters (0.375 inches), divet depth 127 may be 1.27 centimeters (0.5 inches) or 0.9525 centimeters (0.375 inches), and divet height 128 may be 1.27 centimeters (0.5 inches) or 0.9525 centimeters (0.375 inches).

FIG. 3 illustrates a perspective view of an embodiment of main body 101 of pastry cover 100. Main body 101 of pastry cover 100 has a pastry height 114, a pastry depth 116, and a pastry width 118. In some aspects, pastry width 118 is equal to pastry depth 116. In other aspects, pastry width 118 is greater than pastry depth 116. In further aspects, pastry width 118 is lesser than pastry depth 116. Additionally, pastry height 114 may be equal to, greater than, or less than pastry width 118 and or pastry depth 116. Pastry cover 100 may have a thickness 188 between 1 mil (0.001 inches) to 500 mil (0.5 inches). In some aspects, thickness 188 may be 10 mil (0.01 inches).

Distances between each candle holding divet 120 may vary. Main body 101 of pastry cover 100 may have a horizontal distance 130 between candle holding divets 120, a vertical distance 132 between candle holding divets 120, and a diagonal distance 134 between candle holding divets 120. Horizontal distance 130 may be greater than, equal to, or lesser than vertical distance 132 and/or diagonal distance 134. Vertical distance 132 may be greater than, equal to, or lesser than horizontal distance 130 and/or diagonal distance 134. Diagonal distance 134 may be greater than, equal to, or lesser than horizontal distance 130 and/or vertical distance 132. Horizontal distance 130, vertical distance 132, and diagonal distance 134 may each vary between 1 centimeter (approximately 0.393701 inches) and 13 centimeters (approximately 5.11811 inches). In some embodiments, horizontal distance 130, vertical distance 132, and diagonal distance 134 may each, either in tandem or alternative, be greater than 13 centimeters (approximately 5.11811 inches).

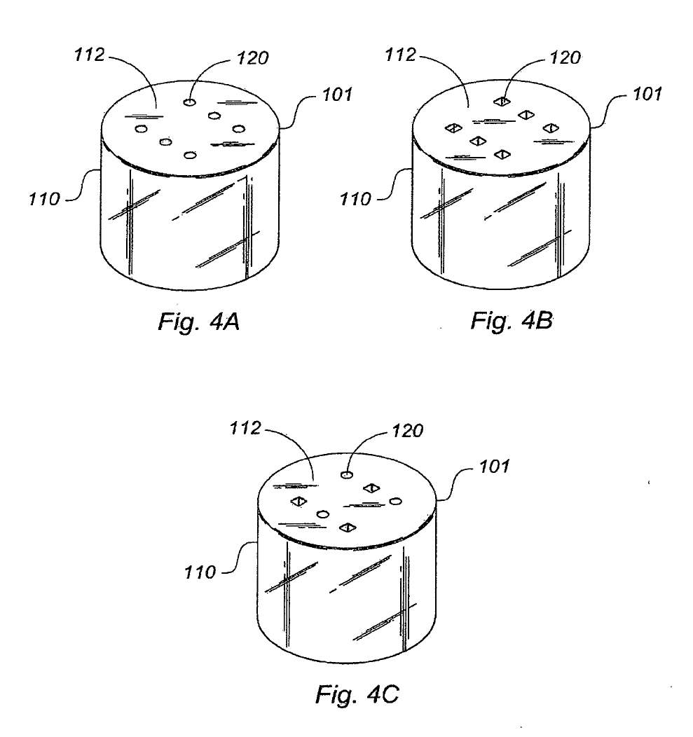

FIGS. 4A-4C illustrate perspective views of main body 101 of pastry cover 100. Candle holding divets 120 may be of various shapes including circular, rectangular, or square. FIG. 4A illustrates candle holding divets 120 with a circular shape. FIG. 48 illustrates candle holding divets 120 with a rectangular shape. In embodiments with rectangular shaped candle holding divets 120, each divet width 126 is greater than or less than each divet depth 127. FIG. 4C illustrates candle holding divets 120 with circular and square shapes. In embodiments with square shaped candle holding divets 120, each divet with 126 is equal to each divet depth 127. Further, as illustrated in FIG. 4C, in some embodiments a main body 101 of pastry cover 100 may include candle holding divets 120 with more than one shape. For instance, a main body 101 of pastry cover may include candle holding divets 120 with rectangular and square shapes, rectangular and circular shapes, square and circular shapes, or rectangular, square, and circular shapes.

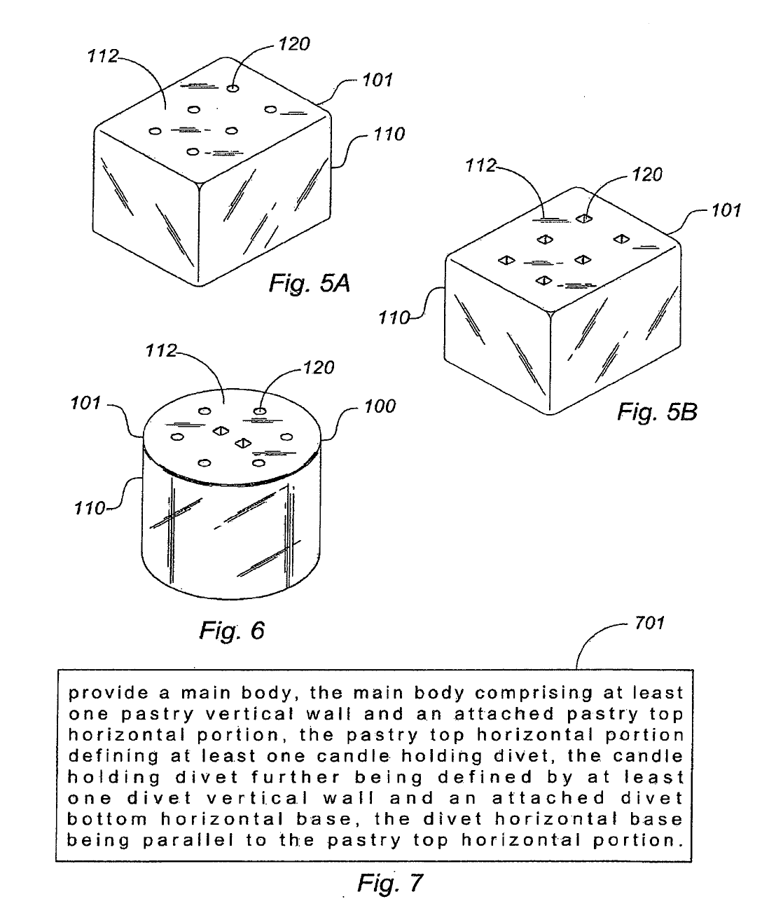

FIGS. 5A and 58B illustrate perspective views of the main body 101 of pastry cover 100. Embodiments of main body 101 of pastry cover 100 may be of various shapes including circular, rectangular, and square. FIG. 5A illustrates a main body 101 of pastry cover 100 with a rectangular shape. FIG. 5B illustrates a main body 101 of pastry cover 100 with a square shape. FIGS. 4A-4C illustrate a main body 101 of pastry cover 100 with a circular shape. Each shape of a main body 101 of pastry cover 100 may have various shapes of candle holding divers 120. For example, a main body 101 of pastry cover 100 with a circular shape may include candle holding divets of only circular shape, only rectangular shape, only square shape, rectangular and square shapes, rectangular and circular shapes, square and circular shapes, or rectangular, square, and circular shapes. A main body 101 of pastry cover 100 with a rectangular shape may include candle holding divers of only circular shape, only rectangular shape, only square shape, rectangular and square shapes, rectangular and circular shapes, square and circular shapes, or rectangular, square, and circular shapes. Further, a main body 101 of pastry cover 100 with square shape may include candle holding divets of only circular shape, only rectangular shape, only square shape, rectangular and square shapes, rectangular and circular shapes, square and circular shapes, or rectangular, square, and circular shapes.

A main body 101 of pastry cover 100 with a circular shape may be considered to have only one pastry vertical wall 110 which wraps fully around the pastry top horizontal portion 112. A main body 101 of pastry cover 100 with a rectangular or square shape, may be considered to have four pastry vertical walls 110 with are joined to full wrap around pastry top horizontal portion 112. Main body 101 of pastry cover 100 may include any number of candle holding divets 120, such as, but not limited to, 1, 3, 5, 7, or 10. In some embodiments, main body 101 of pastry cover 100 may include up to 100 candle holding divets 120. In further embodiments, main body 101 of pastry cover 100 may have more than 100 candle holding divets 120. Main body 101 or pastry cover 100 may be made of a variety of materials that are transparent and/or non-transparent. Main body 101 or pastry cover 100 may be made of a variety of materials including, but not limited to, plastic. The various size and shapes of each candle holding divet 120 and main body 101 of pastry cover 100 may be configured to accommodate a variety of candle shapes, types, and sizes for a variety of occasions.

FIG. 6 illustrates an exemplary pastry cover 100 with a circular shape of main body 101. Main body 101 has at least one pastry vertical wall 110 attached to a pastry top horizontal portion 112. As shown in FIG. 6, main body 101 has various shapes of candle holding divets 120 includes two rectangular divets 120 in the center of the horizontal portion 112 surrounded by 6 evenly spaced circular divets 120. The divets 120 as shown in FIG. 6 are each 0.635 centimeters (0.25 inches).

Turning to FIG. 7, showing a method of making pastry wall 100. Step 701 includes providing a main body, the main body comprising at least one pastry vertical wall and an attached pastry top horizontal portion, the pastry top horizontal portion defining at least one candle holding divet, the candle holding divet further being defined by at least one divet vertical wall and an attached divet bottom horizontal base, the divet horizontal base being parallel to the pastry top horizontal portion.

Whereas, the construction and method have been described in relation to the figures of the drawings, it should be understood that other and further modifications, apart from those shown or suggested herein, may be made within the spirit and scope of this invention.

What is claimed:

1. A pastry cover for holding candles, the pastry cover comprising:
a main body, said main body comprising at least one pastry vertical wall and an attached pastry top horizontal portion,
the pastry top horizontal portion defining at least one candle holding divet, the candle holding divet further being defined by at least one divet vertical wall and an attached divet bottom horizontal base, the divet horizontal base being parallel to the pastry top horizontal portion.

2. The pastry cover of claim 1, wherein the at least one candle holding divet is square in shape, the candle holding divet further being defined by at least four divet vertical walls each attached to the divet bottom horizontal base.

3. The pastry cover of claim 1, wherein the at least one candle holding divot is circular in shape.

4. The pastry cover of claim 1, wherein the divet width of the divet horizontal base is between 0.5 centimeters and 13 centimeters.

5. The pastry cover of claim 4, wherein the divet length of the candle holding divet is 0.635 centimeters.

6. The pastry cover of claim 4, wherein the divet length of the candle holding divet is 2 cm.

7. The pastry cover of claim 4, wherein the length of the divet length of the candle holding divet between 0.635 centimeters and 3 centimeters.

8. The pastry cover of claim 7, wherein the main body is comprised of transparent material.

9. The pastry cover of claim 7, wherein the main body has a thickness of between 1 mil and 500 mil.

10. The pastry cover of claim 7, wherein the main body is rectangular in shape.

11. The pastry cover of claim 7, wherein the main body is circular in shape.

12. The pastry cover of claim 7, wherein the main body is square in shape.

13. The pastry cover of claim 7, wherein the pastry top horizontal portion defines two or more candle holding divets.

14. The pastry cover of claim 7, the pastry top horizontal portion defining 5, 7, or 10 candle holding divets.

15. The pastry cover of claim 13, wherein the two or more candle divets are spaced between 1 cm and 13 cm apart from one another.

16. A method of making a pastry cover for holding candles, the method comprising:
providing a main body, the main body comprising at least one pastry vertical wall and an attached pastry top horizontal portion,
the pastry top horizontal portion defining at least one candle holding divet, the candle holding divet further being defined by at least one divet vertical wall and an attached divet bottom horizontal base, the divet horizontal base being parallel to the pastry top horizontal portion.

17. The method of claim 16, wherein the width of the divet horizontal base is between 0.635 centimeters and 13 centimeters.

18. The method of claim 17, wherein the length of the divet vertical wall is between 0.635 centimeters and 3 cm.

19. The method of claim 18, wherein the pastry top horizontal portion defines two or more candle holding divets.

20. The method of claim 19, wherein the two or more candle divets are spaced between 1 centimeter and 13 centimeters apart from one another.
